(19) United States
(12) Patent Application Publication
(10) Pub. No.: US 2024/0125173 A1
(43) Pub. Date: Apr. 18, 2024

(54) APPARATUS FOR REUSING WASTEWATER AS GREYWATER

(71) Applicant: Anthony Jeremiah Bayne, Lomita, CA (US)

(72) Inventor: Anthony Jeremiah Bayne, Lomita, CA (US)

(21) Appl. No.: 18/380,170

(22) Filed: Oct. 14, 2023

Related U.S. Application Data
(60) Provisional application No. 63/416,514, filed on Oct. 15, 2022.

(51) Int. Cl. E06B 9/52

(52) U.S. Cl. CPC E06B 9/52

(57) ABSTRACT

An apparatus, including a window frame, a window screen, and an apparatus to fit in a window screen frame's lower horizontal track embodiment. Each apparatus embodiment allows household wastewater to be easily passed through it and outside for reuse as greywater in a greywater system.

### BACKGROUND OF THE INVENTION

### Field of Invention

The invention relates to conserving water, and more specifically relates to a new apparatus to reuse wastewater as greywater.

### Description of Related Technology

Droughts are a common occurrence in the Southwestern United States of America, and other parts of the world. Many people conserve water by using less of it. In addition, others conserve water by reusing household wastewater (i.e., wastewater without fecal contamination). Wastewater that is reused is called “greywater”. For example, a person may catch water in a bucket while taking a shorter shower and reuse it later as greywater to water a tree. Likewise, after a boiling an egg a person may remove the egg with tongs, allow the water to cool, and then take the remaining wastewater outside to reuse it as greywater to water a plant.

Since moving a bucket, or pot, of wastewater may cause it to slosh over the brim and onto the floor, it is a problem to move wastewater this way. Further, since a US gallon of water weighs about 8.3 pounds, the water's heaviness makes the problem of moving wastewater through a home or office even more burdensome.

Therefore, there remains a need to address the peculiar challenges in the prior art to provide a way to more easily move wastewater outside for reuse as greywater to encourage water conservation.

### BRIEF SUMMARY OF THE CERTAIN INVENTIVE ASPECTS

To overcome the aforesaid problems of moving wastewater outside for reuse in a as greywater, disclosed is a new window screen frame, window screen, and apparatus that enables a user to shorten the distance that wastewater must be moved, to easily pass it through them, outside, to reuse in a greywater. These new shortcuts will encourage users to conserve water, by making it easy for them to reuse household wastewater as greywater.

In a preferred embodiment, the invention comprises a window screen frame. The window screen frame includes an interior facing side, an exterior facing side, a hole configured to allow wastewater to pass into the window screen frame's interior facing side and out of the exterior facing side outside for reuse as greywater. The window screen frame may comprise four sections, and at least one of the four sections includes a height, as measured from the outside edge of the frame section to the inside edge of the frame section, that is greater than two of the window screen frame's other sections.

In an alternate embodiment, the invention includes a window screen. The window screen includes an opening that is configured to allow wastewater to pass through the window screen opening outside for reuse as greywater. The opening may be located on the screen at a height that is at, or below, the midpoint of a window screen frame's height that holds the window screen.

In an alternate embodiment, the invention includes an apparatus for a window screen frame's track. The apparatus is configured to be placed lengthwise in a window screen frame's track, and further comprises an interior facing side, an exterior facing side, a top length side, a hole configured to allow wastewater to pass through the apparatus for reuse as greywater, and a track located on the top length side edge of the apparatus. The track is configured to receive, support, and hold a window screen frame's lowest horizontal section (or in alternate embodiment a vertical section of the window screen frame) by bracketing the window screen frame's lowest section between the inner walls of the apparatus's track's slot.

In an alternate embodiment, the invention includes an apparatus that is positionable in a window screen frame's track in front of an installed window screen's interior facing side, including a vertical member that further includes a hole; and the hole substantially aligns with a hole in the window screen to allow wastewater to pass through each of them for reuse as greywater. The hole is configured to support a funnel to easily pour wastewater outside for reuse as greywater. The vertical member may be held upright by a base that sits substantially under a window frame's lowest side. Alternatively, or in addition to the base support, an edge of the vertical member may be held between an interior surface of the window frame track and an internal facing side of the window frame.

In another alternate embodiment, the invention includes a kitchen window frame for a greywater system. The kitchen window frame comprises a downward sloping hole that begins on an interior facing side of the frame, and ends at an exterior facing side of the frame; and the hole is further configured to allow wastewater to pass through the hole and out of the exterior facing side of the frame for use in a greywater system. The hole is located below the window frame's lowest horizontal track.

Without limiting the scope of this invention as expressed by the claims that follow, its more prominent features will now be discussed briefly. After considering this discussion, and particularly after reading the section entitled “DETAILED DESCRIPTION OF THE INVENTION”, one will understand how the features of this invention provide advantages that include the improved collection of wastewater for reuse in a greywater system.

Although the following description of exemplary embodiments will be presented in the context of a window proximate to a kitchen sink, other windows proximate to a water source (e.g., a bathroom window proximate to a shower) are contemplated to be included.

The invention, now having been briefly summarized, may be better visualized by turning to the following drawings wherein like elements are referenced by like numerals.

To the accomplishment of the above and related objects, the present invention may be embodied in the form illustrated in the accompanying drawings. However, the drawings are illustrative only, and changes may be made in the specific construction(s) illustrated and described that are within the scope of the claims.

Although, the invention is described herein in terms of various exemplary embodiments and implementations, the various features, aspects, and functionality described in one or more of the individual embodiments are not limited in their applicability to the embodiment with which they are described. Instead, they can be applied, alone or in various combinations, to one or more of the other embodiments of the invention, whether such embodiments are explicitly described and whether such features are presented as being a part of a described embodiment. Thus, the breadth and scope of the present invention should not be limited by any of the above-described exemplary embodiments.

The presence of broadening words and phrases such as “one or more,” “at least,” “but not limited to”, or other like phrases, shall not be read to mean that the narrower case is intended, or required, where such broadening phrases may be absent.

The objects and features of the present invention will become more fully apparent from the following description and appended claims, taken in conjunction with the accompanying drawings. Understanding that these drawings depict only typical embodiments of the invention and are not to be considered limiting of its scope, the invention will be described and explained with additional specificity and detail using the accompanying drawings.

### BRIEF DESCRIPTION OF THE DRAWINGS

FIG. 1 shows a perspective view of a window screen frame including a hole to pass wastewater through the frame in accordance with the present invention.

FIG. 2 shows a front view of the window screen frame in FIG. 1, in accordance with the present invention.

FIG. 3 shows a rear view of the window screen frame in FIG. 1, in accordance with the present invention.

FIG. 4 shows a side view of the window screen frame in FIG. 1, in accordance with the present invention.

FIG. 5 shows a front view of a window screen alternate embodiment, including an opening and cover, for use in a greywater system in accordance with present invention.

FIG. 6 shows a rear view of the window screen in FIG. 5.

FIG. 7 shows a side view of FIG. 5.

FIG. 8 shows a perspective view of an alternate embodiment apparatus for use in a greywater system, in accordance with the present invention.

FIG. 9 shows a front view of FIG. 8, including a tension spring.

FIG. 10 shows a sideview of FIG. 8.

FIG. 11 shows a top view of FIG. 8.

### DETAILED DESCRIPTION OF THE INVENTION

The following detailed description is directed to certain specific embodiments of the invention. However, the invention can be embodied in a multitude of diverse ways as defined and covered by the claims. In this description, reference is made to the drawings wherein like parts are designated with like numerals throughout.

The present invention solves the aforesaid problems by providing a new window screen frame, a window screen, and an apparatus that supports a window screen frame, to allow wastewater to easily pass outside for reuse as greywater as part of a greywater system, as will be discussed below.

Most window screen frames have four sides. The sides include four sections that may be joined together at their ends by a connector to form a square or rectangle shaped window screen frame. A window screen (aka “insect screen”) is installed into the completed window screen frame using a rubber strip that is pushed into a groove of the window screen frame to secure the screen. How window frames and window screens are assembled are well known by those proficient in the art, and so are not described in further detail herein. The four sections are constructed of the same material (e.g., aluminum), generally have the same dimensions (e.g., height and width), and only vary in their length when the window screen shape is not a square.

In all three embodiments of the invention, a hole or opening is included to permit wastewater to pass into the interior facing side (of the frame, screen, or apparatus) and out of the exterior facing side, so that the wastewater can be reused as greywater in a greywater system. Additionally, for all three embodiments of the invention, a cover for the interior facing side of the hole may be included to cover the hole to keep out insects when not in use.

However, with or without a cover on an interior facing side, in a preferred embodiment of the window screen frame and apparatus embodiment, the interior facing side of the hole is higher than the exterior facing side of the hole to allow water to drain easily through them, outside, for reuse as greywater.

In a preferred embodiment of the window screen frame embodiment, the hole may be located on the lowest horizontal section of the frame. In an alternative embodiment the hole may be located on a vertical section of the window screen frame.

These and other features, aspects and embodiments of the invention will be described in more detail below.

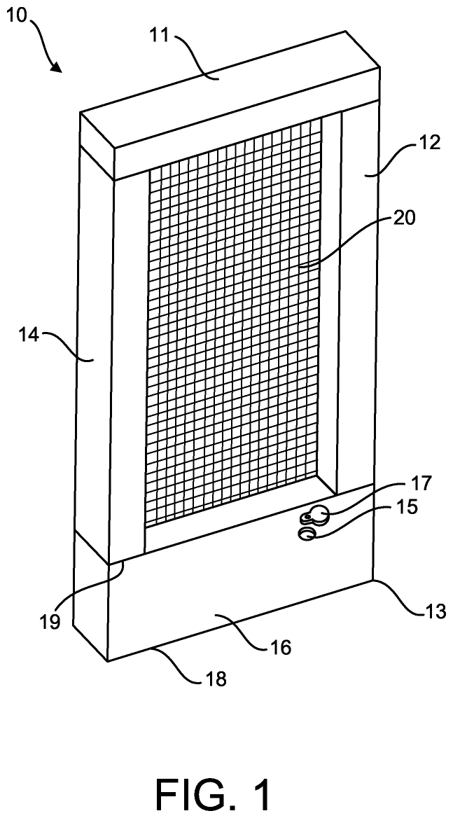

FIG. 1 is a perspective view of a window screen frame 10 including four sections 11-14 and a hole 15 that begins on the interior facing side 16 of the frame 10. A cover 17 is shown attached to the interior facing side 16 of the frame 10 to cover the hole 15. Each of the four sections 11-14 of the window screen frame 10 may be made of the same material (e.g., aluminum). In an alternate embodiment, the sections 11-14 may each be made of a different material, or combination of them. For example, the section 13 that includes the hole 15 may be made of additional material, a different material, or a combination of materials, different than the other sections (11, 12 and 14), to make the section 13 that includes the hole 15 more durable, stiffer, rust resistance, etc., than at least two other sections (e.g., 12 &14) of the frame 10. Additionally, the section 13 that includes the hole 15 may include a height that is greater than at least two other sections (e.g., 12 and 14). The height of the section 13 that includes the hole 15 is measured from the outside edge 18 of the section 13 to the inside edge 19 of the section 13. The section 13 that includes the hole 15 is taller to accommodate additional hardware (e.g., a hook to hold a shower head), or other structural elements designed to funnel water into the hole 15. In an alternate embodiment, the section 13 that includes the hole 15 may be the same height as the other frame sections (11, 12 and 14). The window screen frame 10 is shown including a window screen 20, sometimes also referred to as an insect screen.

While the hole 15 is shown in the frame's 10 lowest section 13, in an alternate embodiment, the hole 15 may be in a vertical section 12 or 14 of the window screen frame 10.

The hole 15 that passes through the window frame 10 section 13 creates a shortcut for a user to pass wastewater (e.g., water left over from boiling an egg) outside for reuse as greywater, without having to carry/transport the wastewater through the house and risk spillage. For example, when the window screen frame 10 is installed near a kitchen sink, a user who has over filled a coffee pot (filled the coffee pot up with water sufficient to make ten cups of coffee, but only wanted enough water for eight cups) could choose to pour the excess water (wastewater) through the hole 15 for reuse as greywater in a greywater system, instead of pouring the excess water down the kitchen drain (i.e., a loss of water use), or carrying it outside for reuse (i.e., a burden). Passing wastewater through the hole 15 outside is convenient and can be directed by a downspout, or other conduit, into a collection receptacle (e.g., bucket) for reuse as greywater in a greywater system.

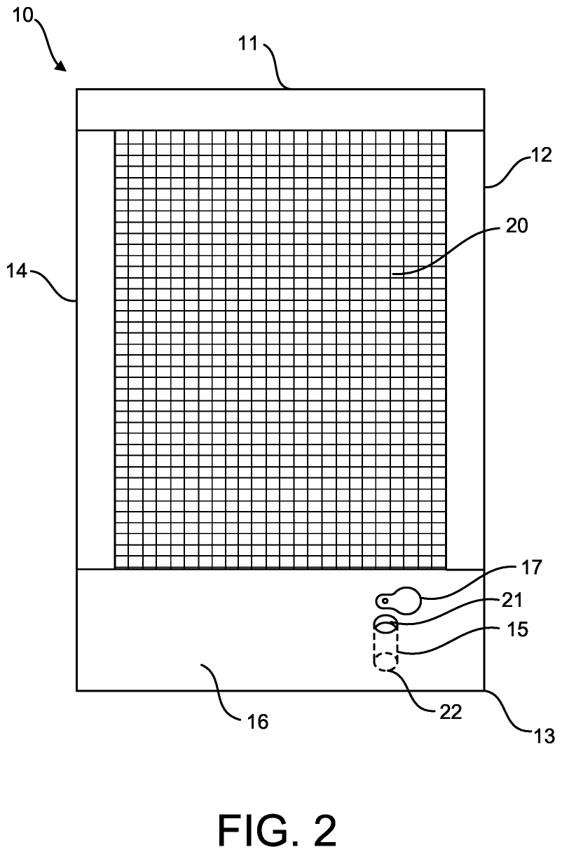

FIG. 2 shows a front view of a window screen frame 10, including a window screen 20 and four sections 11-14. The lowest horizontal section 13 includes a hole 15 to allow wastewater to pass through the section 13 outside for reuse in a greywater system. The hole 15 has a first end 21 and a second end 22. The first end 21 is located on the interior facing side 16 of the frame 10 and is higher than the second end 22, to allow water to easily drain outside for reuse as greywater in a greywater system. In an alternate embodiment, the hole 15 may be located on a vertical section (i.e., 12 or 14) of the frame 10. The frame 10 further includes an attached hole cover 17 to prevent insects from coming indoors when not in use. The hole 15 may further comprise a rust resistant tube when the section 13 including the hole 15 is hollow, or additional rust protection, leak protection, etc., is desired.

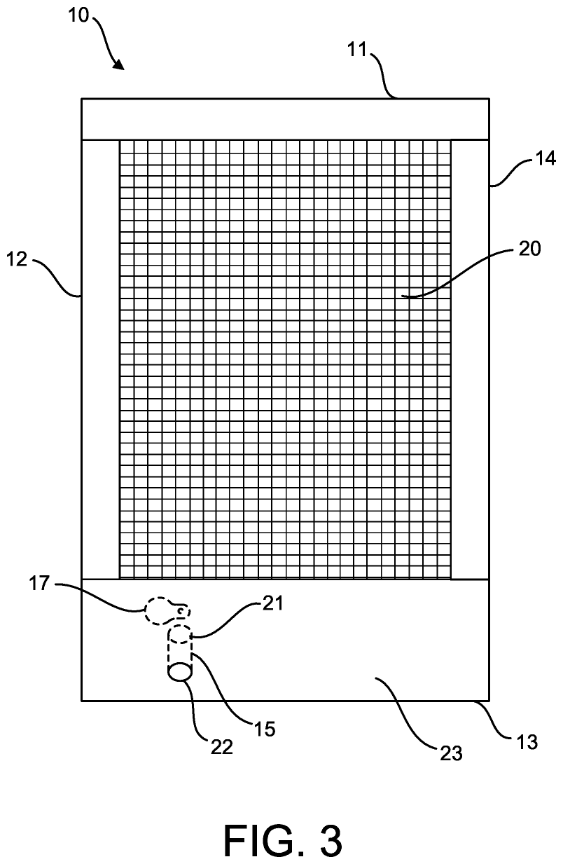

FIG. 3 shows a rear view of a window screen frame 10, including four sections 11-14 and a window screen 20. The hole's 15 second end 22 terminates on the exterior facing side 23 of the frame 10 and is lower than the hole's 15 first end 21. A hole cover 17 is located on the interior facing side 16 of the frame 10. In an alternate embodiment, a cover 17 may be located on the exterior facing side 23 of the frame 10.

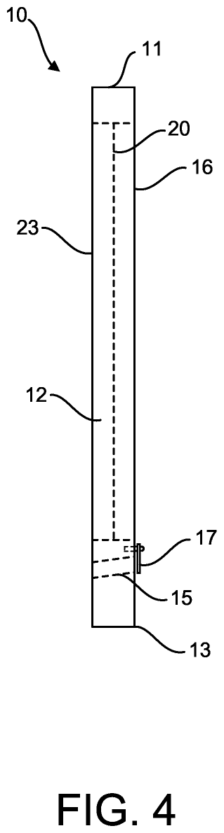

FIG. 4 shows a side view of a window frame 10, including a screen 20 and a lower section 13 that further includes a downward sloping hole 15. The frame 10 includes a hole 15 and a hole 15 cover 17. The hole 15 comprises a conduit including a first end 21 that begins on the interior facing side 16 of the frame 10 and a second end 22 that ends on the exterior facing side 23 of the frame 10. The first end 21 is higher than the second end 22, so that the hole 15 slopes downward to allow wastewater to drain easily outside for reuse in a greywater system. In an alternative embodiment, a downward sloping hole 15 may be located on a vertical section (i.e., 12 or 14) of the frame 10. In a preferred embodiment the hole 15 will be located, at or below, the midpoint of the window screen frame's 10 height.

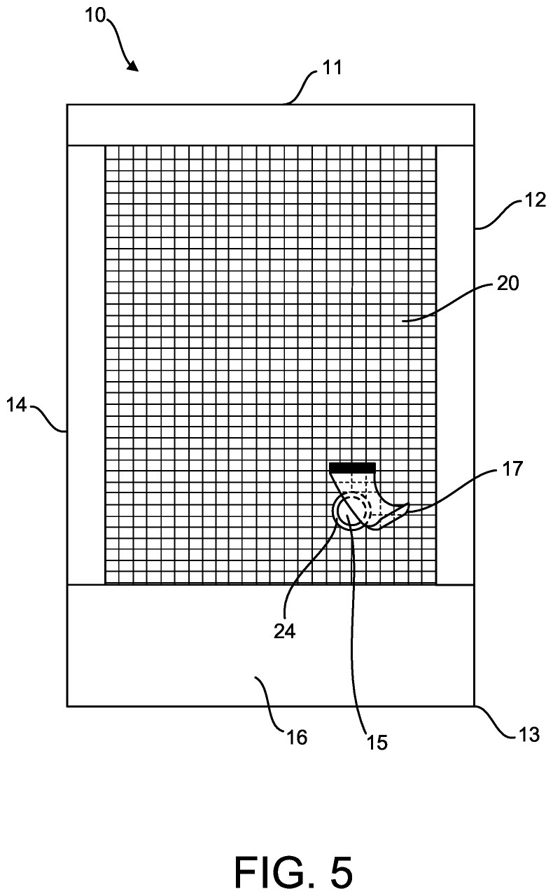

FIG. 5 shows a front view of an alternate embodiment, including a window screen 20 for a window screen frame 10 to enable the reuse of wastewater as greywater in a greywater system. In this embodiment the hole 15 is in the window screen 20, and in a preferred embodiment, the hole's 15 edge is protected by a reinforcement 24 (e.g., a rubber ring) to prevent the hole 15 from tearing from repeated use (e.g., from inserting a funnel through the screen 20 hole 15). Alternatively, the hole 15 may be reinforced by additional screen 20 material, or other material affixed to the edge of the hole. Further, a hole cover 17 is attached to the window screen 20 to cover the hole 15 to keep out insects when not in use. In a preferred embodiment, the hole 15 cover 17 may be attached to the interior facing side 16 of the screen 20. The cover 17 may be constructed of the material used for the screen 20, canvas, or other suitable material(s).

The screen 20 is shown being held by the frame's 10 four sections 11-14, but the screen 20 may be used for any window screen frame 10 configuration utilizing a screen 20.

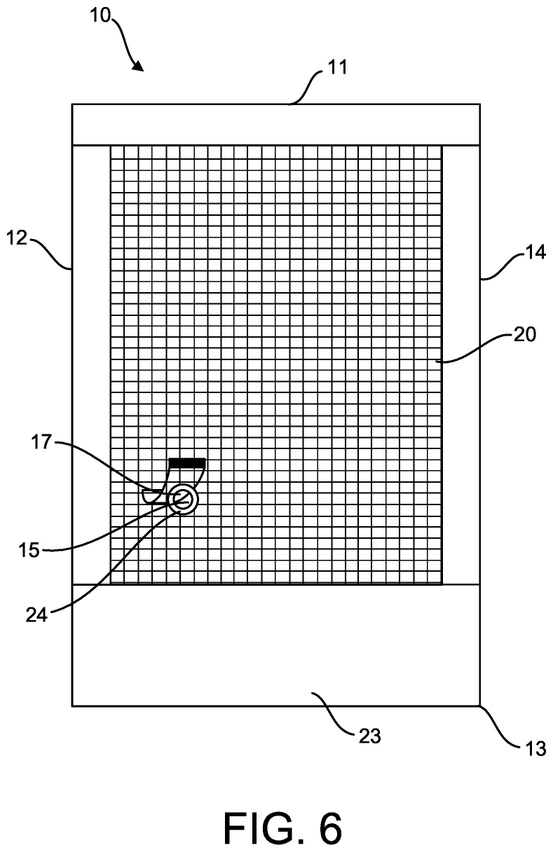

FIG. 6 shows a rear view, exterior facing side 23, of the alternate window screen 20 embodiment in FIG. 5, including the hole 15, a hole reinforcement 24, and a hole cover 17. The screen 20 is held by a frame 10 that includes four sections 11-14, but may be held by magnets, or other means.

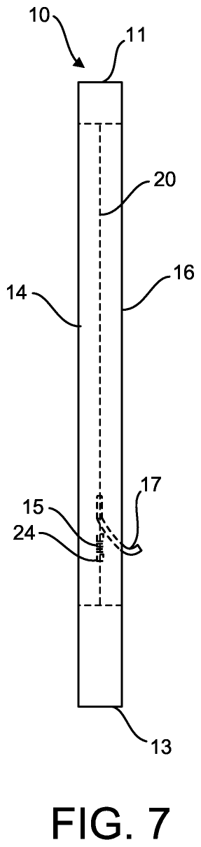

FIG. 7 shows a side view of the alternate window screen 20 embodiment in FIG. 5, including a hole 15, a hole reinforcement 24 and a hole cover 17. The window screen 20 is held by a window screen frame 10 that includes four sides 11-14. However, the window screen 20 may be used for any window screen frame 10 configuration. The cover 17 is accessible from the interior facing side 16 of the screen 20, but in an alternate embodiment the cover 17 may be located on the exterior facing side 23, or on each side (16 & 23) of the screen's 20 hole 15.

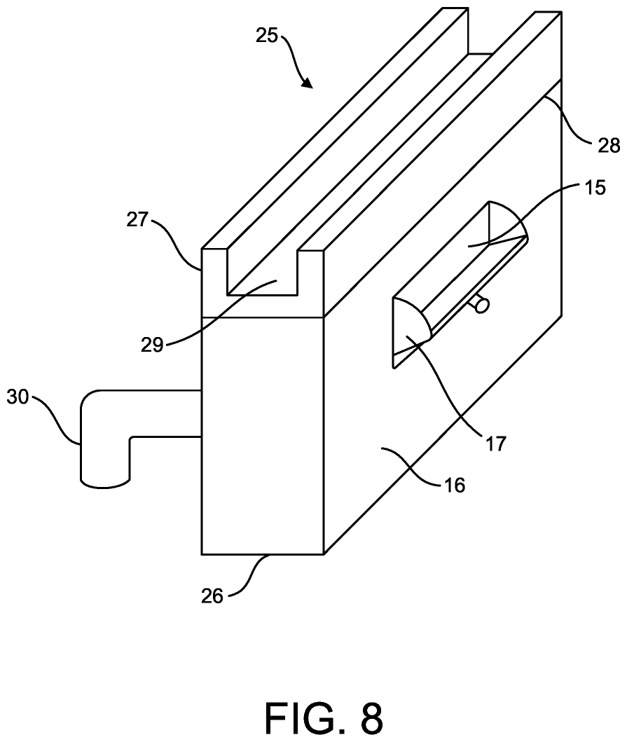

FIG. 8 shows a perspective view of an apparatus 25 for a greywater system. The apparatus 25 comprises a bottom 26 that is configured to fit in a window screen frame's lower horizontal track. The apparatus 25 further comprises a track 27 on the top length side 28 of the apparatus 25 to receive, support, and hold a window screen frame (e.g., a window screen frame's bottom horizontal section) in the track's 27 slot 29. In an alternate embodiment, in lieu of a track 27, or in addition to the track 27, a clip, a bracket, a fixture, a hollow, or a groove may be used to hold a window screen frame. Further, in an alternate embodiment, the track 27 may be of a one-piece construction, integral to the material of the bottom 26 of the apparatus 25.

The apparatus 25 further comprises a hole 15, and a hole cover 17. The hole 15 cover 17 is preferably located on the interior facing side 16 of the apparatus 25. The hole 15 slopes downward to a downspout 30 that provides a convenient connection point for a greywater system (e.g., to attach a garden hose that empties at a base of a tree). Further, the downspout 30 may be positionable (e.g., twists 90-180 degrees) to allow the apparatus 25 to be placed in a window screen frame's 10 vertical track. In an alternate embodiment, the downspout 30 may be removably attached to the apparatus 25 (e.g., the downspout 30 may screw into the exterior facing side 23 of the apparatus 25).

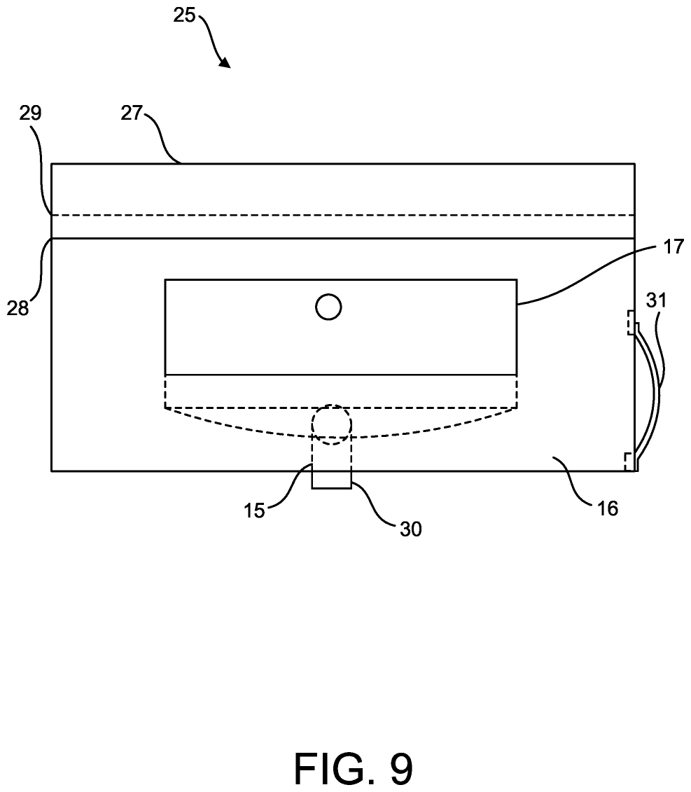

FIG. 9 shows a front view of the apparatus 25 in FIG. 8. The apparatus 25 includes a track 27 on its top length side 28. The track 27 includes a slot 29 to receive, support, and hold a window screen frame's bottom section. The apparatus 25 further includes a downward sloping hole 15 and a hole cover 17. Wastewater is poured into the hole 15 from the interior facing side 16 and exits from the downspout 30. The apparatus 25 may include a tension spring 31 to hold the apparatus 25 securely in a window screen frame's lower horizontal track.

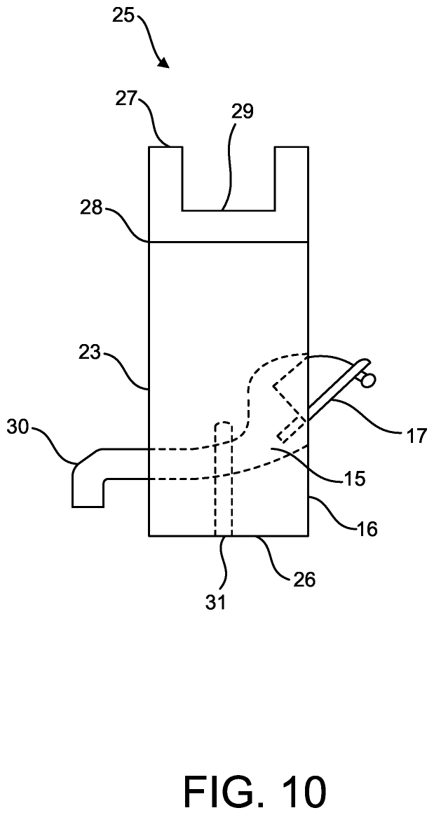

FIG. 10 shows a side view of the apparatus 25 for use in a greywater system, comprising a bottom 26 configured to fit in a window screen frame's lower horizontal track and a top length side 28 including a track 27. The track 27 further includes a slot 29 to receive, support, and hold a window screen frame's bottom section. The apparatus 25 further includes a downward sloping hole 15 that feeds into a downspout 30 located on the exterior facing side 23. A hole 15 covering 17 is preferably located on an interior facing side 16 of the apparatus 25 and may be opened and closed as needed. The apparatus 25 may include a tension spring 31 to hold the apparatus 25 securely in a window screen frame's lower horizontal track.

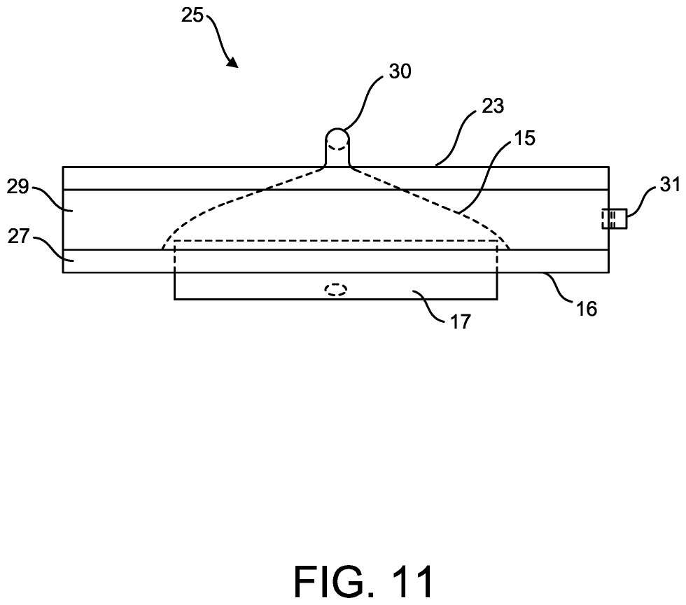

FIG. 11 shows a top view of the apparatus 25, including a track 27 on the top of the apparatus 25, that further includes a slot 29 to receive, support, and hold a window screen frame. The apparatus 25 includes a hole 15 that begins on the interior facing side 16 and passes through the apparatus 25 to direct wastewater into a downspout 30 located on the exterior facing side 23. A hole cover 17 may function like a funnel to direct water into the hole 15 and downspout 30. For example, the cover 17 may open downward, so that its inner cover 17 surface will act like a funnel (e.g., opens like a freestanding US Mail box slot to receive letter sized envelopes). A tension spring 31 may be attached to at least one end of the apparatus 25 to hold it securely in place in a window screen frame's lower track.

The disclosed invention teaches a new tool for use in a greywater system, and alternate embodiments, that unlike prior art tools, provide a convenient way to move wastewater out of a home (or office) for reuse as greywater in a greywater system. Many alterations and modifications may be made by those having ordinary skill in the art without departing from the spirit and scope of the invention.

Therefore, it must be understood that the illustrated embodiments have been set forth only for the purposes of examples and that they should not be taken as limiting the invention as defined by the following claims. For example, notwithstanding the fact that the elements of a claim are set forth below in certain combination, it must be expressly understood that the invention includes other combinations of fewer, more, or different ones of the disclosed elements.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted, and what incorporates the essential idea of the invention.

I claim:

1. A window screen frame for use in a greywater system, comprising:
a window screen frame for use in a greywater system,
the window screen frame further comprising an interior facing side, an exterior facing side; and
a hole configured to allow wastewater to pass into the window screen frame's interior facing side and out of the exterior facing side for reuse as greywater.

2. The window screen frame of claim 1, further comprising four sections; and
at least one of the four sections includes a height, as measured from the outside edge of the frame section to the inside edge of the frame section, that is greater than two of the window screen frame's other sections.

3. The window screen frame of claim 1, further comprising four sections; and
one of the four sections is stiffer than two other sections of the window screen frame and includes the hole.

4. The hole of claim 1, further being located at, or below, the midpoint of the window screen frame's height.

5. The window screen frame of claim 1, further including a hole cover.

6. The cover of claim 5, further being located on the window screen frame's interior facing side.

7. The hole of claim 1, further comprising two ends, including a first end that begins on the interior facing side of the window screen frame, a second end that terminates at the exterior facing side of the window screen frame; and
the first end is higher than the second end.

8. A window screen for a greywater system, comprising:
a window screen for a greywater system, the window screen further includes an opening configured to allow wastewater to pass through the opening for reuse in a greywater system.

9. The opening of claim 8 further being located on the screen at a height that is at, or below, the midpoint of a window screen frame's height that holds the window screen.

10. The opening of claim 8, further including a reinforced edge.

11. The window screen of claim 8, further including an opening cover that is attached to the window screen.

12. An apparatus for use in a greywater system, comprising:
an apparatus for use in a greywater system that is configured to be placed in a window screen frame's track, the apparatus further comprises an interior facing side, an exterior facing side, a top length side, a hole configured to allow wastewater to pass through the apparatus for reuse as greywater; and
a track located on the top length side of the apparatus configured to receive a window screen's frame.

13. The track located on the top length side of the apparatus of claim 12, further comprising a group, the group comprising one of a clip, a bracket, a fixture, a groove, or a slot.

14. The track located on the top length side of the apparatus of claim 12 further being located above the hole.

15. The hole of claim 12, further including a downward slope, the downward slope beginning at the interior facing side of the apparatus and ending at the exterior facing side of the apparatus.

16. The apparatus of claim 12, further including a spout on the exterior facing side.

17. The apparatus of claim 12 further including a hole cover located on the interior facing side of the apparatus.

18. The hole cover of claim 17, further opening downward.

19. The apparatus of claim 12, including a window screen tension spring.

20. The window screen frame track of claim 12, comprising a group, the group including one of a bottom window screen frame track, or a vertical window screen frame track.
